(19) United States
(12) Patent Application Publication
(10) Pub. No.: US 2025/0308754 A1
(43) Pub. Date: Oct. 2, 2025

(54) COIL COMPONENT AND BOARD DEVICE

(71) Applicant: Taiyo Yuden Co., Ltd., Tokyo (JP)

(72) Inventors: Masuo YATABE, TOKYO (JP); Taisuke SUZUKI, TOKYO (JP); Daizo YOKOYAMA, TOKYO (JP)

(21) Appl. No.: 19/089,970

(22) Filed: Mar. 25, 2025

(30) Foreign Application Priority Data
Mar. 28, 2024 (JP) JP2024-053796

(51) Int. Cl. H01F 27/29; H01F 27/24; H01F 27/32

(52) U.S. Cl. CPC H01F 27/29; H01F 27/24; H01F 27/32

(57) ABSTRACT

A coil component includes a magnetic base body containing metal magnetic particles. The magnetic base body has a first surface and a second surface adjacent to each other such that a ridge is defined between the first surface and the second surface. The coil component also includes a conductor provided in or on the magnetic base body. The coil component also includes an insulating layer extending from the first surface to the second surface over the ridge. The coil component also includes an external electrode electrically connected to the conductor. The external electrode is provided on the first surface and spaced from the ridge.

### CROSS REFERENCE TO RELATED APPLICATIONS

This application makes reference to, claims a priority to, and claims benefit from Japanese Patent Application No. JP2024-053796, filed on Mar. 28, 2024, which is hereby incorporated herein by reference in its entirety.

### FIELD OF THE DISCLOSURE

This disclosure relates to a coil component and a board device.

### DESCRIPTION OF THE RELATED ART

With rapid progress of downsizing and high performance of digital electronic devices, there is an increasing need to increase the density of electronic circuits mounted on a single board (substrate). To meet such need, there is a demand for a surface-mounted electronic component that can deal with a reduction in land areas of the substrate by providing external electrodes only on a bottom surface of the electronic component. The bottom surface of the electronic component is a surface that is mounted on the substrate. The external electrodes provided only on the bottom surface of the electronic component are often referred to as one-sided electrodes.

For example, JP 2020-061409A discloses a laminated electronic component that has one-sided external electrodes and can enhance the adhesion between the external electrodes and a base body (element body) of the electronic component. The element body is a magnetic body, and a portion of the element body enters a concave wedge portion of each of the external electrodes.

### SUMMARY OF THE DISCLOSURE

If the surface-mounted electronic component that has the external electrodes as disclosed in JP 2020-061409A is used, the surface reduction of the external electrodes due to the downsizing of the electronic component reduces the joining strength (adhesion) between the external electrodes and the substrate, thereby deteriorating the mechanical reliability.

In particular, the adhesion between the external electrodes and the substrate of the coil component drops if a solder fillet, which is generated upon mounting the coil component to the substrate, wets up the surface of the magnetic base body.

An object of the present disclosure is to enhance the adhesion between the coil component and the substrate, thereby enabling high-density mounting of a plurality of coil components on a single substrate.

Additional or separate features and advantages of this disclosure will be set forth in the descriptions that follow and in part will be apparent from the description, or may be learned by practice of the disclosure. The objectives and other advantages of the disclosure will be realized and attained by the structure particularly pointed out in the written description and claims thereof as well as the appended drawings.

To achieve these and other advantages and in accordance with the objective of the present disclosure, as embodied and broadly described, in one aspect, the present disclosure provides a coil component that includes a magnetic base body containing metal magnetic particles. The magnetic base body has a first surface and a second surface adjacent to each other such that a ridge is defined between the first surface and the second surface. The coil component also includes a conductor provided in or on the magnetic base body. The coil component also includes an insulating layer formed on the magnetic base body such that the insulating layer extends from the first surface to the second surface over the ridge. The coil component also includes an external electrode provided on the first surface such that the external electrode is electrically connected to the conductor and spaced from the ridge.

A distance from the first surface to a farthest portion of the external electrode in a direction perpendicular to the first surface may be greater than a distance from the first surface to a farthest portion of the insulating layer.

A distance from the farthest portion of the insulating layer to the farthest portion of the external electrode in the direction perpendicular to the first surface may be smaller than the distance from the first surface to the farthest portion of the insulating layer.

The insulating layer may cover the second surface of the magnetic base body.

The insulating layer may be made of resin and ceramic particles.

The external electrode may include a base electrode layer and a plating layer provided on the base electrode layer. The plating layer may be in contact with the insulating layer.

A part of an outer periphery of the base electrode layer of the external electrode may be covered with the insulating layer. The plating layer may be provided inside the outer boundary (outer periphery) of the base electrode layer.

The base electrode layer may have a flat portion that is flush with the first surface or at a recessed position from the first surface.

If the base electrode layer has a flat portion that is flush with the first surface, the flat portion may be covered with the insulating layer.

According to another aspect of the present disclosure, there is provided a device that includes the above-described coil component and a board having a land portion to which the external electrode is soldered. The solder connects between the land portion and the external electrode to form a solder fillet that is spaced from the second surface.

According to still another aspect of the present disclosure, there is provided a device that includes the above-described coil component and a board having a land portion to which the external electrode is soldered. The solder connects between the land portion and the external electrode to form a solder fillet within an outer dimension of the coil component.

According to the present disclosure, it is possible to enhance the adhesion between the coil component and the board (substrate). As a result, when a plurality of coil components are mounted on a single board, high-density mounting of the coil components becomes possible.

### BRIEF DESCRIPTION OF THE DRAWINGS

FIG. 1 is a perspective view of a coil component according to an embodiment of the present disclosure.

FIG. 2 is a bottom view of the coil component shown in FIG. 1 with a dotted line.

FIG. 3 is a schematic cross-sectional view of the coil component shown in FIG. 1, taken along the III-III line in FIG. 1.

FIG. 4 is an enlarged view of a lower left corner of a coil component according to a comparative example to show a shape of a solder fillet formed in the comparative example.

FIG. 5 is similar to FIG. 4 and shows an enlarged view of a lower left corner of the coil component of FIG. 3 to show a shape of the solder fillet formed in the embodiment.

FIG. 6 shows a configuration when the thickness of the solder is reduced.

FIG. 7 is a graph showing impact test results for the comparative example and the embodiment of FIG. 1.

FIG. 8 shows a modification in which the numbers of external electrodes is different from FIGS. 1 and 2.

FIG. 9 is a cross-sectional view of a modification in which external electrodes are different from FIG. 3.

FIG. 10 is a bottom view of the modification shown in FIG. 9.

FIG. 11 shows a modification in which the insulating layers are formed over a larger area than FIG. 3.

FIG. 12 shows a modification in which the insulating layers are formed over a smaller area than FIG. 3.

### DETAILED DESCRIPTION OF EMBODIMENTS

The following is a detailed description of embodiments of this disclosure with reference to the accompanying drawings. The following embodiments are not intended to limit the disclosure, and not all of the combinations of features described in the embodiments are essential for the configuration of the disclosure. The configuration of the embodiments may be modified or changed if necessary depending on the specifications of the device to which the disclosure is applied and various conditions (conditions of use, environment of use, etc.).

The technical scope of the disclosure is defined by the claims and is not limited by the following individual embodiments. The drawings used in the following description may differ in scale and shape from the actual structure in order to make each configuration easier to understand. Parts, elements, and components shown in one of the drawings may be referred to in the description of other drawings.

### One Embodiment of a Coil Component

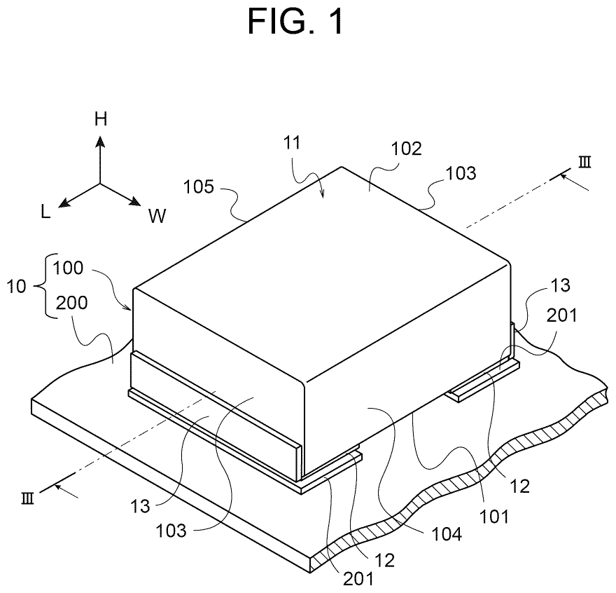

FIG. 1 is a perspective view of a coil component 100 according to an embodiment of the present disclosure.

The coil component 100 is mounted on a substrate (board) 200. The substrate 200 is provided with, for example, two land portions 201. The coil component 100 has, for example, two external electrodes 12. The coil component 100 is mounted on the substrate 200 by joining the two external electrodes 12 with the two land portions 201, respectively, by solder.

A circuit board (board device) 10 includes the coil component 100 and the board 200 on which the coil component 100 is mounted. The circuit board 10 may be used in various electronic devices. The electronic device having the circuit board 10 may be an electric component of an automobile, a server, a board computer, or various other electronic devices.

The coil component 100 may be an inductor, a transformer, a filter, a reactor, or various other coil components. The coil component 100 may be a coupled inductor, a choke coil, or various other magnetically coupled coil components. The coil component 100 may be, for example, an inductor used in a DC/DC converter. The application of the coil component 100 is not limited to those specified herein.

In this specification, unless the context otherwise requires, the description of the direction is based on the L-axis direction, the W-axis direction, and the H-axis direction in FIG. 1. The L-axis direction is a length direction. The W-axis direction is a width direction. The H-axis direction is the height direction.

The coil component 100 has, for example, a rectangular parallelepiped shape. The coil component 100 has outer surfaces (right and left surfaces) at opposite ends in the length direction L, outer surfaces (top and bottom surfaces) at opposite ends in the height direction H, and outer surfaces (front and rear surfaces) at opposite ends in the width direction W. The rectangular parallelepiped shape of the coil component 100 has eight corners and twelve ridges.

The dimensions of the sides of the rectangular parallelepiped-shaped coil component 100 are such that the dimension in the length direction L is, for example, in the range of 1.0 mm to 4.5 mm, the dimension in the width direction W is, for example, in the range of 0.5 mm to 3.2 mm, and the dimension in the height direction H is, for example, in the range of 0.5 mm to 2.0 mm. The dimension of the coil component 100 in the height direction H is smaller than the dimension in the length direction L. The dimension of the coil component 100 in the height direction H is smaller than the dimension in the width direction W.

Each of the outer surfaces of the coil component 100 may be a flat plane, a curved surface, or a surface having a step (convex/concave) in a part thereof. The eight corners and the twelve ridges of the coil component 100 may be rounded.

In this specification, even when a part of the outer surface of the coil component 100 is curved or has a step, or when a corner portion or a ridge portion of the coil component 100 has a rounded shape, the coil component 100 having such a shape may be referred to as a rectangular parallelepiped shape component. In other words, in this specification, the term “rectangular parallelepiped” or “rectangular parallelepiped shape” does not mean “rectangular parallelepiped” in a mathematically strict sense.

### Structure of the Coil Component

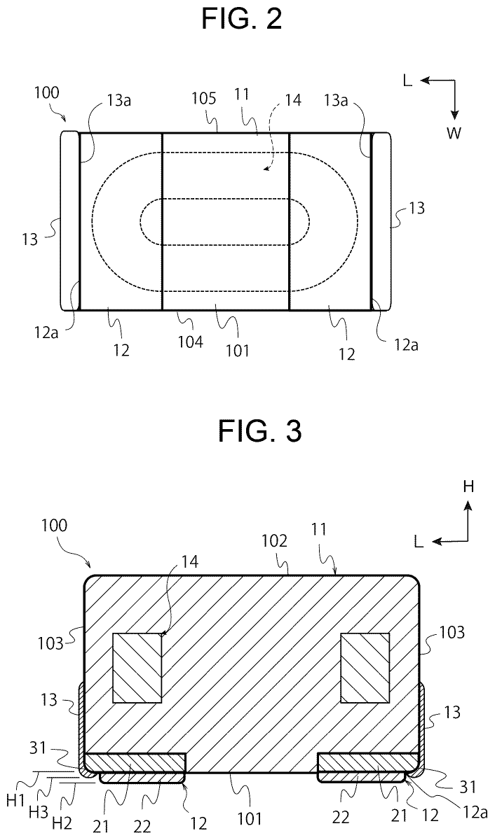

FIG. 2 is a bottom view of the coil component 100 shown in FIG. 1 with a dotted line, and FIG. 3 is a schematic cross-sectional view of the coil component 100. FIG. 3 shows a cross section taken along the III-III line in FIG. 1. Hereinafter, description will be given with reference to FIGS. 1 to 3.

The coil component 100 has a magnetic base body 11, the external electrodes 12, and an insulating layer 13. A conductor 14 is provided in the magnetic base body 11.

The base body 11 has, for example, a six-sided shape, and has, for example, a rectangular parallelepiped shape. That is, the base body 11 has a bottom surface 101 at one end in the height direction H, and has an upper surface 102 at the other end in the height direction H. The base body 11 has side surfaces 103 at both ends in the length direction L. The base body 11 has a front surface 104 at one end in the width direction W, and a rear surface 105 at the other end in the width direction W. The upper surface 102 may be referred to as a top surface.

The bottom surface 101 may be referred to as a “first surface,” and the side surface 103 may be referred to as a “second surface.”

The upper surface 102 is a surface opposite to the bottom surface 101, i.e., the upper surface 102 faces upward and the bottom surface 101 faces downward. The upper surface 102 is adjacent to the side surfaces 103, the front surface 104, and the rear surface 105. Similarly, the bottom surface 101 is adjacent to the side surfaces 103, the front surface 104, and the rear surface 105. If two surfaces are adjacent to each other, these two surfaces are in a positional relationship in which other surfaces are not interposed between the two adjacent surfaces. One ridge is defined by each two adjacent surfaces. In the illustrated embodiment, the adjacent surfaces are orthogonal to each other.

The ridge 31 defined between the bottom surface 101 and the side surface 103 of the magnetic base body 11 has a round surface.

The magnetic base body 11 in the illustrated embodiment is a magnetic body formed of a metal magnetic material and a binding material (binder). The magnetic base body 11 may be made by a lamination method, a green powder method, or a mold method.

The binding material (binder) couples the metal magnetic materials to each other. The binder is highly insulating in order to prevent electrical conduction. The binder is selected such that the resistivity of the magnetic base body 11 becomes equal to or greater than 10⁶ Ωcm. For example, a binder having a resistivity of 10⁸ Ωcm or more is selected (used). For the purpose of increasing the mechanical strength, a binder may be selected from resins, glasses, and metal oxides. The binder may be selected such that the surface resistance of the magnetic base body 11 becomes 10⁵ Ω/sq. or more.

Since the metal magnetic material containing Fe as a main component is less resistive, it is desirable to adjust the components and the blending ratio of the binder in accordance with the metal magnetic material. The binder has, for example, a resistivity of 10⁸ Ωcm or more. For the purpose of enhancing the insulating property, a resin may be included in the binder, and glass and a metal oxide may be used as components other than the resin.

The magnetic base body 11 has a very high internal resistivity, and the same is true on the surface of the magnetic base body 11. The binder material is also present on the surface of the magnetic base body 11. The metal magnetic material includes metal magnetic particles containing one or more components of Fe, Ni, and Co. The metal magnetic material may include, in addition to the metal magnetic particles, one or more of Mg, Mn, and Ni ceramic magnetic particles or non-magnetic particles such as silica. The metal magnetic particles may include, in addition to Fe, Ni, and Co component(s), one or more components of Si, Cr, Al, B, and P, or a plurality of types of metal magnetic particles may be combined.

The metal magnetic material has a particle size of between 1 μm and 60 μm. When the metal magnetic material further includes other materials such as metal fine particles, metal oxides, and ceramic materials in addition to the metal magnetic particles, the average particle size of the above-mentioned “other materials” is 0.01 μm to 1 μm, and this particle size is smaller than that of the metal magnetic particles. When materials other than the metal magnetic particles are included, the voids may be reduced and/or the mechanical strength may be enhanced for, rather than enhancing the functions of the magnetism. The magnetic base body 11 has a metallic magnetic material filling ratio of between 80 vol % and 88 vol %, and the balance is other than the metallic magnetic material and includes an insulator or voids.

The conductor 14 is made of a metal material having excellent conductivity. The metal material for the conductors 14 includes, for example, one or more metals of Cu, Al, Ni, or Ag, or an alloy containing any of these metals. The conductor 14 may be made by winding a metal conductive wire having an insulating film formed on a surface thereof, or may be made by plating, printing, or the like on a surface of a substrate, a sheet, or the like.

The conductor 14 of this embodiment has a wire-winding portion in which the wire revolves over one turn or more. FIG. 2 and FIG. 3 show the wire-winding portion of the conductor 14. The number of turns of the wire in the wire-winding portion of the conductor 14 is, for example, between 1.5 turns and 10.5 turns. The overall shape of the wire-winding portion may be a planar shape or a spiral shape. It should be noted that the wire-winding portion may have two groups of wire-winding portions that face each other in the height direction of the base body 11 to form, in combination, a single aggregate. FIG. 2 and FIG. 3 show a so-called horizontal wire-winding portion in which the conductive wire revolves generally in parallel to the bottom surface 101 and the upper surface 102 of the base body 11.

Alternatively, the conductor 14 may have a so-called vertical wire-winding portion in which the conductive wire revolves generally in parallel to the side surfaces 103 of the base body 11. The base body 11 may be a drum core type such that the conductor (wire) 14 winds around the outer periphery of the base body 11.

The conductor 14 has two lead-out portions (not shown) for electrical conduction with the outside. The two lead-out portions connect the two external electrodes 12, respectively, to the conductor 14. Thus, the external electrodes 12 are electrically coupled to the conductor 14. The conductor 14 is formed by any one of a winding process, a thin film forming process, and a lamination process, i.e., any suitable process may be employed.

The coil component 100 includes the two external electrodes 12 in the illustrated embodiment. Each of the external electrodes 12 shown in FIGS. 1 to 3 is a one-sided electrode, i.e., the external electrode 12 is only provided on the single surface (bottom surface 101) of the magnetic base body 11.

It should be noted that the term “provided on a surface” or “formed on a surface” means being provided/formed at a position (or in an area) visible when the surface is viewed. A provided item (or a formed item) may extend outward from the surface when viewed in a direction perpendicular to the surface or may extend downward (may be buried) in the direction perpendicular to the surface. As will be described later, a part of each of the external electrodes 12 protrudes downward from the bottom surface 101, and another part of the external electrode 12 is buried in the bottom surface 101. The range of the bottom surface 101 of the magnetic base body 11 is the entire range up to the outer periphery including the region where the external electrodes 12 are provided. The bottom surface 101 in the region where the external electrodes 12 are provided is flat because the unevenness of the bottom surface 101 may be ignored upon providing by the external electrodes 12 on the bottom surface 101.

Each of the external electrodes 12 includes a base electrode layer (underlying electrode layer) 21 and a plating layer 22 on (over) the base electrode layer 21. The thickness of the base electrode layer 21 is, for example, 2 μm to 10 μm, and the thickness of the plating layer 22 is also, for example, 2 μm to 10 μm. The outer surface of the base electrode layer 21 has a planar portion and is generally flush with the bottom surface 101. Alternatively, the outer surface of the base electrode layer 21 may be recessed from the bottom surface 101, and may have a flat portion in the center area of the base electrode layer 21.

When the outer surface of the base electrode layer 21 and the bottom surface 101 of the base body 11 have such a relationship, the thickness of the plating layer 22 is greater than the thickness of the base electrode layer 21, or the thickness of the plating layer 22 is smaller than the thickness of the base electrode layer 21.

Each of the plating layers 22 is provided within the outer periphery of the associated base electrode layer 21 when viewed from the bottom surface 101 of the base body 11. As a result, it is possible to make the plating layer 22 having a constant thickness as a whole. The external electrode 12 may have a metal layer between the base electrode layer 21 and the plating layer 22. The total thickness of the external electrode 12 having the metal layer is, for example, 5 μm to 20 μm. In FIG. 3, for convenience of illustration, the thicknesses of the base electrode layer 21 and the plating layer 22 are shown to be thicker than the actual thicknesses.

Alternatively, the external electrode 12 may include the base electrode layer 21, the plating layer 22, and a conductive resin layer which partially contains a resin therein. The thickness of the conductive resin layer is, for example, 5 μm to 20 μm. The thickness of the base electrode layer 21 and the thickness of the plating layer 22 may be smaller than the thickness of the conductive resin layer. The total thickness of the external electrode 12 having the conductive resin layer is, for example, 10 μm to 30 μm.

The external electrode 12 includes one or both of a layer having the same component (material) as the conductor 14 and a layer having a higher resistance than the conductor 14. The external electrode 12 includes one or both of a layer having the same filling ratio as the conductor 14 and a layer having a filling ratio lower than the conductor 14.

A metallic material such as Ag, Cu, Ti, or Ni is used for the base electrode layer 21. The base electrode layer 21 is provided on the surface of the magnetic base body 11 by plating, coating or printing of a metal material, sputtering, or vapor deposition. Alternatively, the base electrode layer 21 may be formed integrally with the magnetic base body 11 when the magnetic base body 11 is made by a lamination method. A portion of the base electrode layer 21 may be separated from other portions. The base electrode layer 21 is brought into close contact with the surface of the magnetic base body 11 and the lead-out portion of the conductor 14, so that the external electrode 12 is integrated (united) with the magnetic base body 11 and conduction between the external electrode 12 and the conductor 14 is obtained.

Each of the plating layers 22 is made of a metallic material having excellent conductivity. For example, Cu or Ag may be used as the metallic material for the plating layer 22. Alternatively, Ni, Pd or Sn may be used as the metallic material for the plating layer 22. The plating layer 22 is formed in a layered structure by overlapping layers which are mainly composed of the above-mentioned metallic material or layers partially alloyed. The plating layer 22 is provided to increase the strength of soldering to the external electrode 12.

When the external electrode 12 has the above-described metal layer, the metal layer is formed from the same metal material as that of the base electrode layer 21 such that the filling ratio of the metal is higher than that of the base electrode layer 21. The metal layer has lower resistance and higher static strength than the base electrode layer 21.

When the external electrode 12 has the above-described conductive resin layer, the conductive resin layer is made of the same metal material as that of the base electrode layer 21, and the metal material is mixed with the resin. Because the conductive resin layer contains the resin, the resistance of the conductive resin layer is higher than that of the base electrode layer 21, and the impact strength of the conductive resin layer is higher than that of the base electrode layer 21.

The insulating layers 13 are provided on the surface of the magnetic base body 11. Each of the insulating layers 13 extends downward from the side surface 103 to the bottom surface 101 over the ridge 31. The insulating layer 13 is generally present over a lower half of the side surface 103, and covers a part of the bottom surface 101 which is adjacent to the side surface 103. The insulating layer 13 is made of, for example, resin and ceramic particles. The insulating layer 13 has a melting point higher than the melting point of the solder and the reflow temperature at the time of mounting the coil component 100 to the board 200. The insulating layer 13 may be made by printing, or may be formed by a transfer method or dipping.

The insulating layer 13 may be formed before the plating layer 22 is formed, or may be formed after the plating layer 22 is formed. Preferably, the insulating layer 13 is formed before the formation of the plating layer 22 because the extension of the plating to the ridge 31 at the time of the formation of the plating layer 22 is suppressed or prevented. In this configuration, the thickness of the insulating layer 13 can be thin. The insulating layer 13 is provided in a narrow area/range.

In the illustrated embodiment, an edge 13a of the insulating layer 13 and an edge 12a of the external electrode 12 contact with each other, as shown in FIG. 2. The edge 12a of the external electrode 12 refers to the edge of the plating layer 22 of the external electrode 12 close to the side surface 103 (FIG. 3). It should be noted that the insulating layer 13 may be spaced from the external electrode 12.

In the illustrated embodiment, each of the insulating layers 13 is in contact with the associated plating layer 22. The insulating layer 13 covers a part of the outer surface of the base electrode layer 21, and the plating layer 22 is provided within the outer periphery of the base electrode layer 21. With such a relation, the edge 13a of the insulating layers 13 does not exceed the extension line of the edge 12a of the external electrode 12. Preferably, the insulating layer 13 does not exceed the edge 12a of the external electrodes 12 in the length direction L. That is, the insulating layers 13 are not present between the two external electrodes 12, on the front surface 104 and the rear surface 105 of the magnetic base body 11, and on the upper surface 102 of the magnetic base body 11. Therefore, the volume occupied by the insulating layers 13 is small, and the coil component 100 can be made small while maintaining the magnetic characteristics. Accordingly, it is possible to mount a plurality of coil components 100 at high density on a single board.

In FIG. 3, H2 denotes the position (height position) of the farthest portion (lowest portion or the bottom face) of the external electrode 12 from the position H1 of the bottom surface 101 of the base body 11 in the height direction H, and H3 denotes the position of the farthest portion (lowest position or the bottom) of the insulating layer 13 from the position H1 of the bottom surface 101 of the base body 11 in the height direction H. The distance from the position H1 to the position H2 is greater than the distance from the position H1 to the position H3. Thus, the external electrodes 12 protrude outward (downward) from the insulating layers 13 in the direction from the base body 11 toward the substrate 200.

Therefore, the cream solder applied to the surface of the external electrodes 12 is brought into contact with the respective land portions 201 of the substrate 200, and the soldering between the external electrodes 12 and the land portions 201 of the substrate 200 is reliably performed.

The external electrodes 12 are not formed over the ridges 31, but the insulating layers 13 are formed over the ridges 31. Thus, damage to the ridges 31 of the magnetic base body 11 is suppressed or prevented.

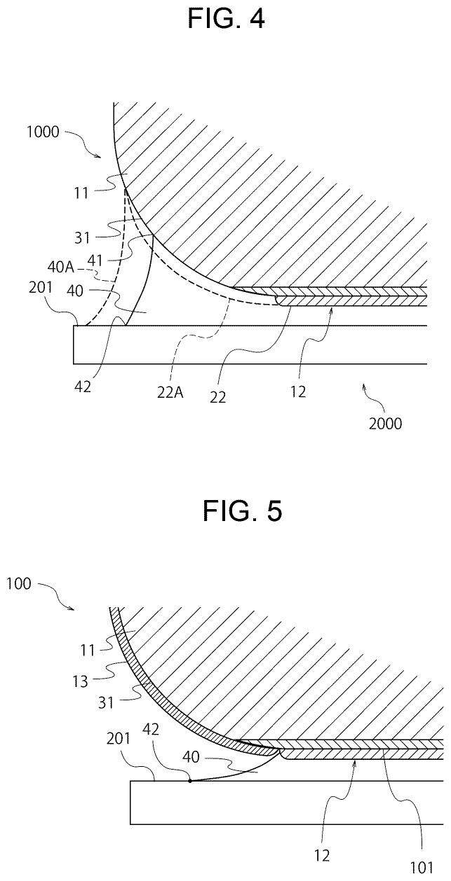

FIG. 4 is an enlarged view of a lower corner of a comparative example (coil component 1000) when the coil component 1000 is mounted on the substrate 200 (FIG. 1) by soldering to make a comparative device 2000. FIG. 4 shows a shape of a fillet of the soldering (shape of a solder fillet). FIG. 5 is an enlarged view of a lower corner of the coil component 100 of FIG. 3 when the coil component 100 is mounted on the substrate 200. FIG. 5 shows a shape of a solder fillet in this embodiment.

The coil component 1000 of the comparative example shown in FIG. 4 is different from the coil component 100 shown in FIG. 3 in that the coil component 1000 does not have the insulating layers 13 of the coil component 100.

If the coil component 1000 of the comparative example is soldered to the land portions 201 of the substrate 200, the solder 40 extends (moves up) onto the round surfaces of the ridges 31 of the magnetic base body 11. As a result, a top 41 of the fillet made of the solder 40 reaches above the position of the external electrode 12, so that the stress generated upon distorting of the substrate 200 is concentrated on the respective ridges 31 of the magnetic base body 11. The top 41 may be referred to as an apex.

In the coil component 1000 of the comparative example, therefore, peeling of the solder 40 and chipping of the ridge 31 are likely to occur in the vicinity of the top 41 of each of the solder fillets, and adhesion between the land portion 201 and the associated external electrode 12 is deteriorated. In addition, since the outermost point 42 of the solder fillet is close to the outer periphery of the land portion 201, peeling of the solder 40 from the substrate 200 is likely to occur starting from the outer periphery of the land portion 201.

As indicated by the dotted line 22A in FIG. 4, the plating layer 22 of the external electrode 12 may exceed the ridge 31 due to plating elongation or the like and extend to the side surface 103 of the base body 11. If the plating layer 22 of the external electrode 12 exceeds the ridge 31, the fillet of the solder 40 exceeds the range (outer boundary) of the external dimensions of the coil component 1000, as indicated by the dotted line 40A.

On the other hand, when the coil component 100 of this embodiment shown in FIG. 5 is soldered to the land portions 201 of the substrate 200, the range (outermost point 42) of the solder 40 is away from the side surface 103 (FIG. 1) of the magnetic base body 11. The solder 40 is formed at a position away from the ridge 31 of the magnetic base body 11. That is, the range in which the solder 40 is provided remains on the bottom surface 101 of the magnetic base body 11.

As a result, the stress from the substrate 200 spreads out (disperses) to the bottom surface 101. Therefore, the coil component 100 of this embodiment can enhance the adhesion between the land portions 201 and the respective external electrodes 12.

In addition, since the wetting up (upward movement) of the solder 40 is restricted by the insulating layers 13, the fillet made by solder 40 has a shape flared along each of the land portions 201 on the substrate 200, and the solder 40 does not reach the bottom surface 101 of the magnetic base body 11. Also, the outermost point (outermost position) 42 of the solder fillet is not close to the outer periphery of the land portion 201.

Therefore, the range in which the solder fillet is formed is small, and the outermost point 42 of the solder fillet is located on the inner side away from the outer periphery of the land portion 201, so that the stress from the substrate 200 is concentrated on the inner side of the land portion 201, and the adhesion between the substrate 200 and the land portion 201 is less or hardly affected by the stress from the substrate 200. That is, the stress starting from the outer periphery of the land portion 201 is relaxed, and the separation of the coil component 100 from the substrate 200 is less likely or hardly to occur.

In order to further enhance the adhesion between the land portions 201 and the external electrodes 12, it is desirable that the thickness of the solder 40 be smaller.

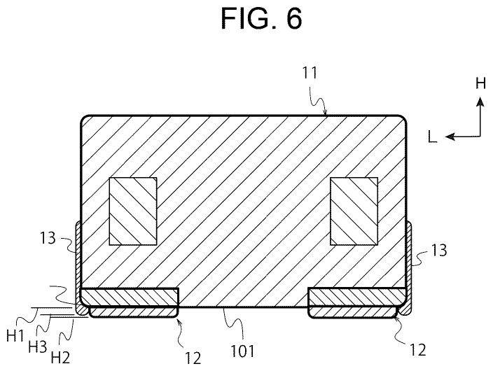

FIG. 6 shows a configuration of the coil component when the solder 40 having a thickness smaller than FIG. 5 is used to join the coil component to the board 200 by soldering.

In the configuration illustrated in FIG. 6, the lowest position H3 of the insulating layers 13 is lowered compared to FIG. 3. Consequently, the distance in the height direction H between the lowest position H2 of the external electrode 12 and the lowest position H3 of the insulating layer 13 is smaller than the distance in the height direction H between the position H1 of the bottom surface 101 and the lowest position H3 of the insulating layer 13.

That is, the lowest position H3 of the insulating layer 13 is located between the position H1 of the bottom surface 101 and the lowest position H2 of the external electrode 12, and is closer to the lowest position H2 of the external electrode 12. By providing the insulating layer 13 to meet such positional relationship, it is possible to cope with the reduction in the thickness of the solder 40. As the thickness of the solder 40 becomes smaller, the fillet of the solder also becomes smaller, which contributes to further enhancement of the adhesion between the land portion 201 and the external electrode 12.

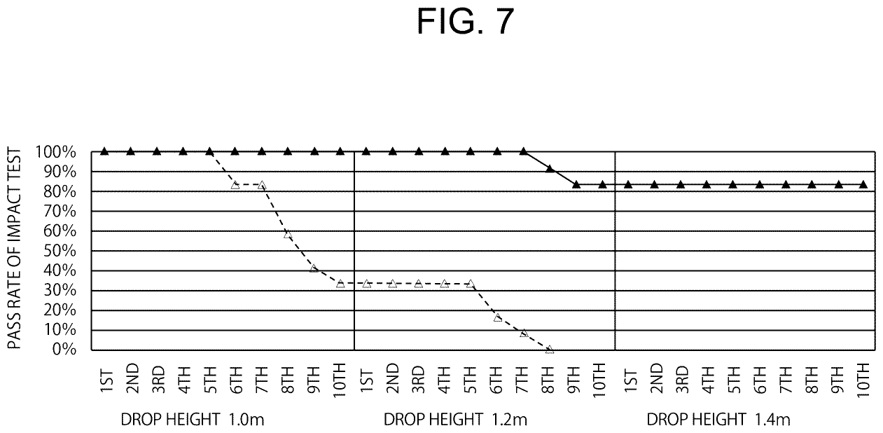

FIG. 7 is a graph showing results of impact tests for the comparative example (FIG. 4) and this embodiment (FIG. 5).

In the graph of FIG. 7, the horizontal axis indicates the number of tests, and the vertical axis indicates the pass rate. In the graph of FIG. 7, the black triangle (▴) and the solid line represent the impact test results of this embodiment, and the white triangle and the broken line represent the impact test results of the comparative example. A plurality of devices 10 and 2000 were used in the impact tests. Each of the devices 10 included the coil component 100 mounted on the board 200. Each of the devices 2000 included the coil component 1000 mounted on the board 200.

In the impact test results, a total of 30 impacts (total of 30 impact tests) were applied to each of the devices 10, 2000 while increasing the impact energy applied to the center area of the respective device 10, 2000 stepwise every 10 tests. In the first ten tests, the impact energy corresponding to the drop from the height of 1.0 meter was applied to the respective device 10, 2000. In the second ten tests, the impact energy increased from the impact energy corresponding to the drop from the height of 1.0 meter to the impact energy corresponding to the drop from the height of 1.2 meter. In the third ten tests, the impact energy increased to the impact energy corresponding to the drop from the height of 1.4 meter.

The coil components 1000 of some of the devices 2000 came off the boards 200 in 10 tests or less when the impact corresponding to the drop height 1.0 meter was applied to all the devices 2000. The pass rate decreased to about 30% when the 10 impacts (10 tests) were applied to the devices 2000. Then, the remaining device 2000 (about 70% of the devices 2000) underwent the next 10 tests, i.e., the impact corresponding to the drop height 1.2 meter was applied to the remaining devices 2000. Then, all the remaining devices 2000 of the comparative example became disqualified (the coil component came off the board 200) in the second 10 tests, and the pass rate dropped to 0%.

On the other hand, the passing rate of the devices 10 was 100% after the first 10 impact tests corresponding to the drop height 1.0 meter. After the second 10 impact tests corresponding to the drop height 1.2 meter, some of the devices 10 were disqualified, but the pass rate was 80% or more. Even after the third 10 impact tests corresponding to the drop height 1.4 meter, the pass rate of 80% or more was maintained.

As described above, it was confirmed that the adhesion between the land portions 201 and the external electrodes 12 is improved by providing the insulating layers 13.

### Modifications

Now, modifications to the coil component 100 will be described. In the following, duplicate descriptions of elements similar to those described above will be omitted.

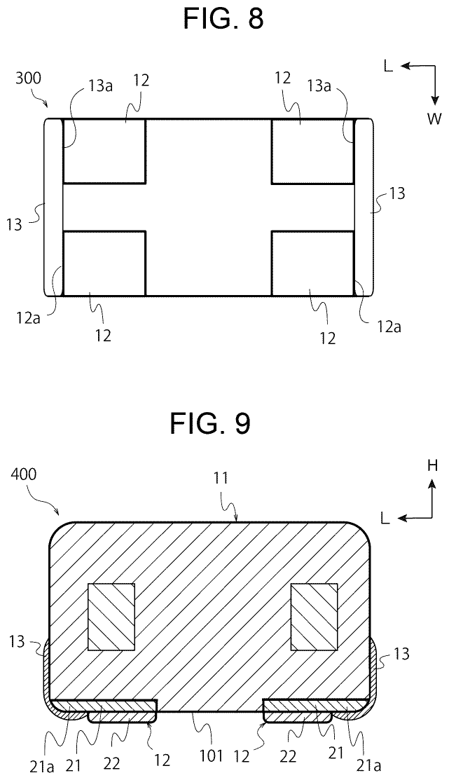

FIG. 8 shows a first modification (coil component 300), in which the number of external electrodes 12 is different from FIG. 2.

The coil component 300 shown in FIG. 8 is a composite component such as a transformer. The coil component 300 includes two pairs of external electrodes 12 (i.e., four external electrodes 12 in total). The left two external electrodes 12 contact the left insulating layer 13, and the right two external electrodes 12 contact the right insulating layer 13. In the coil component 300, the edge 13a of each of the insulating layers 13 does not exceed the edge 12a of each of the associated external electrodes 12 and does not exceed the extension line of the edge 12a. Therefore, the total volumes occupied by the insulating layers 13 is small. If a plurality of coil component 300 are mounted on the board 200, it is possible to mount the coil components 300 at high density.

FIG. 9 and FIG. 10 show, in combination, a second modification (coil component 400), in which the structure of the external electrodes is different from FIGS. 2 and 3. A cross-sectional view of the coil component 400 is shown in FIG. 9 and a bottom view of the coil component 400 is shown in FIG. 10.

In the coil component 400 illustrated in FIGS. 9 and 10, each of the plating layers 22 is made smaller such that a certain portion 21a of the base electrode layer 21 is not covered with the plating layer 22. This portion 21a is a planar portion and extends along the bottom surface 101 of the base body 11. The planar portion 21a is present between the insulating layer 13 and the base body 11. The insulating layer 13 extends on the bottom surface 101 such that the insulating layer 13 covers the planar portion (exposed portion) 21a and reaches the plating layer 22.

Since each of the base electrode layers 21 of the coil component 400 has the planar portion 21a, the stress applied to the plating layer 22 via the solder 40 is dispersed without being concentrated on the outer edge of the base electrode layer 21, and thus the adhesion between the land portion 201 and the external electrode 12 is further improved.

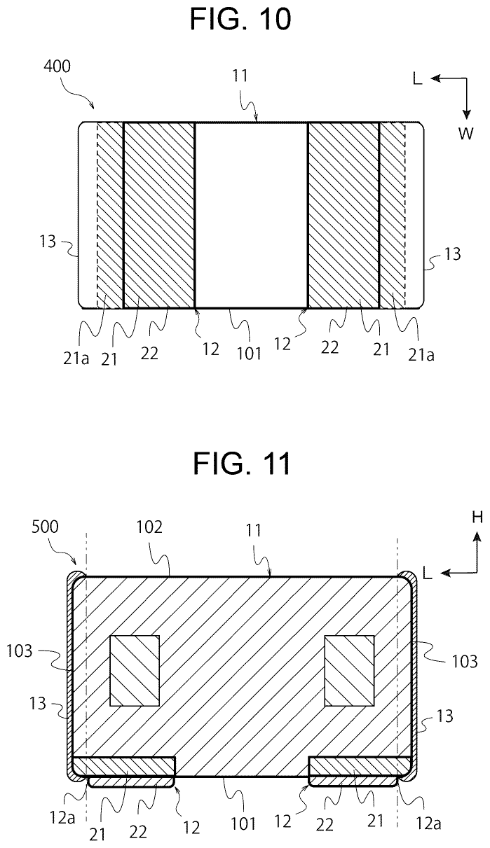

FIG. 11 shows a third modification (coil component 500), in which the formation area (range) of the insulating layers 13 is larger than FIG. 3.

In the coil component 500 shown in FIG. 11, each of the insulating layers 13 covers the entire side surface 103 of the magnetic base body 11. The insulating layer 13 also reaches the bottom surface 101, the upper surface 102, the front surface 104, and the rear surface 105, but the insulating layer 13 does not exceed the edge 12a of the external electrode 12 in the length direction L on any surface. The insulating layer 13 shown in FIG. 11 has high adhesion to the magnetic base body 11. The insulating layer 13 shown in FIG. 11 is easily formed by a dipping method or the like.

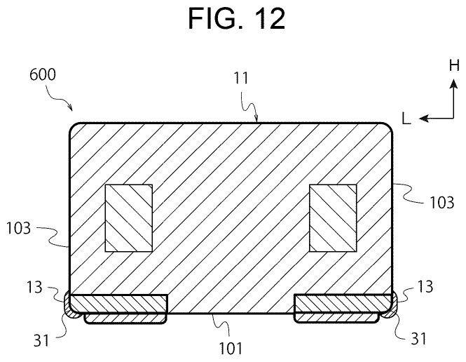

FIG. 12 shows a fourth modification (coil component 600), in which the formation area of the insulating layers 13 is smaller than FIG. 3.

In the coil component 600 shown in FIG. 12, each of the insulating layers 13 is provided on and around the ridge 31 between the bottom surface 101 and the side surface 103. The insulating layer 13 generally extends along the ridge 31 in the width direction D. The insulating layer 13 does not extend (spread) in a planar shape on both the bottom surface 101 and the side surface 103, but extends linearly along the ridge 31. The insulating layer 13 of FIG. 12 is the minimum insulating layer 13 that only covers the area of the ridge 31, and the volume occupied by the insulating layer 13 is also the minimum. Therefore, the presence of the insulating layers 13 does not adversely affect the magnetic characteristics of the coil component 600. This feature of the coil component 600 contributes particularly to high-density mounting when a plurality of coil components 600 are mounted on the board 200.

It will be apparent to those skilled in the art that various modifications and variations can be made in the present disclosure without departing from the spirit or scope of the disclosure. Thus, it is intended that the present disclosure covers modifications and variations that come within the scope of the appended claims and their equivalents. In particular, it is explicitly contemplated that any part or whole of any two or more of the embodiments and their modifications described above can be combined and regarded within the scope of the present disclosure.

What is claimed is:

1. A coil component, comprising:
a magnetic base body that includes metal magnetic particles, a first surface, and a second surface, wherein the second surface is adjacent to the first surface such that a ridge is defined between the first surface and the second surface;
a conductor one of in or on the magnetic base body;
an insulating layer that extends from the first surface to the second surface over the ridge; and
an external electrode on the first surface, wherein the external electrode is electrically connected to the conductor, and the external electrode is spaced from the ridge.

2. The coil component according to claim 1, wherein a distance from the first surface to a farthest portion of the external electrode in a direction perpendicular to the first surface is greater than a distance from the first surface to a farthest portion of the insulating layer.

3. The coil component according to claim 2, wherein a distance from the farthest portion of the insulating layer to the farthest portion of the external electrode in the direction perpendicular to the first surface is smaller than the distance from the first surface to the farthest portion of the insulating layer.

4. The coil component according to claim 1, wherein the insulating layer covers the second surface of the magnetic base body.

5. The coil component according to claim 1, wherein the insulating layer includes resin and ceramic particles.

6. The coil component according to claim 1, wherein
the external electrode includes:
a base electrode layer; and
a plating layer on the base electrode layer, and
the plating layer is in contact with the insulating layer.

7. The coil component according to claim 6, wherein
a part of an outer periphery of the base electrode layer of the external electrode is covered with the insulating layer, and
the plating layer is inside the outer periphery of the base electrode layer.

8. The coil component according to claim 7, wherein the base electrode layer has a flat portion that is flush with the first surface or at a recessed position from the first surface.

9. A device, comprising:
a coil component of claim 1;
a board having a land portion to which the external electrode is soldered; and
a solder fillet between the land portion and the external electrode, the solder fillet being spaced from the second surface.

10. A device, comprising:
a coil component of claim 1;
a board having a land portion to which the external electrode is soldered; and
a solder fillet between the land portion and the external electrode, the solder fillet being present within an outer dimension of the coil component.
